(19) United States
(12) Patent Application Publication
(10) Pub. No.: US 2007/0158568 A1
(43) Pub. Date: Jul. 12, 2007

(54) Apparatus and measuring method of aberration coefficient of scanning transmission electron microscope

(76) Inventors: Taisuke Nakamura, Kokubunji (JP); Kuniyasu Nakamura, Musashino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/645,567

(22) Filed: Dec. 27, 2006

(30) Foreign Application Priority Data
Dec. 27, 2005 (JP) 2005-373756

(51) Int. Cl. G21K 7/00

(52) U.S. Cl. 250/311

(57) ABSTRACT

In the type of scanning transmission electron microscopes carrying an aberration corrector, a method of assuring more simplified and manipulatable adjustment of the corrector and a scanning transmission electron microscope having that function are provided. A Ronchigram image is acquired using a spherical standard specimen and parameters necessary for the adjustment are acquired from the thus obtained Ronchigram.

### INCORPORATION BY REFERENCE

The present application claims priority from Japanese application JP 2005-373756 filed on Dec. 27, 2005, the content of which is hereby incorporated by reference into this application.

### BACKGROUND OF THE INVENTION

The present invention relates to a scanning transmission electron microscope provided with a spherical aberration corrector and a method for adjustment of the same and more particularly, to a technique for correcting aberrations in the apparatus by measuring various aberration coefficients from image data of a Ronchigram image.

In an electron microscope such as an SEM (scanning electron microscope) or STEM (scanning transmission electron microscope) utilizing a scanning electron beam, the thinner the probe diameter of scanning electron beam, the higher the resolution of an image to be obtained becomes in general. With the convergent condition for an electron lens to converge an electron beam set up stringently, however, the electron beam undergoes an aberration and even if the probe can be converged in diameter, an acquired electron beam image will blur. Under the circumstances, SEM or STEM carrying an aberration corrector has recently been developed in order that compatibility between the high resolution and the resolution of image can be assured by obtaining an electron beam image through the use of an electron beam removed of aberrations.

Generally, the aberration corrector is comprised of a plurality of multipole lenses and a plurality of rotationally symmetric lenses and when operating the corrector, excitation voltage (or current) of the multipole and rotationally symmetric lenses must be adjusted. Since the excitation voltage can be determined from an aberration coefficient, measurement of the aberration coefficient is necessary for adjustment of the excitation voltage of these lenses. A method disclosed in “Ultramicroscopy 20” by T. Hanai, M. Hibino and S. Maruse, pp. 329-336, 1986 is among methods of measuring aberration coefficients in an STEM by using a Ronchigram. According to the method described in the non-patent document as above, a Ronchigram image is acquired using a specimen of a random structure such as amorphous sample and the diameter of a ring pattern of infinity magnification appearing in the Ronchigram image is measured to calculate an aberration coefficient. In case the resolution of the STEM is restricted mainly by a spherical aberration, a circular line subject to infinity magnification appears in the Ronchigram. This line of infinity magnificatiaon reflects the degree of various kinds of geometrical aberrations involved in an incident electron beam and so the aberration coefficient can be measured on the basis of the radius or shape of the circular line.

### SUMMARY OF THE INVENTION

In the method disclosed in the aforementioned non-patent document, the diameter of an infinity magnification ring pattern is measured by presuming it with the eye. The ring pattern appearing in the Ronchigram image and corresponding to the infinity magnification does not contrast with the neighborhood and is generally difficult to specify. Further, in the method described in the above non-patent document, for measurement of the aberration coefficient, ring patterns of infinity magnification are presumed from at least two Ronchigrams defocused from each other and the aberration coefficient is measured from a change in diameter between the defocused ring patterns. This raises a problem that the adjustment time is increased by time consumed for acquisition of the plural Ronchigrams.

For the same reason, it is also very difficult to set a slice level when the ring pattern is estimated through pixel operation. Accordingly, specifying or identifying a pattern corresponding to the infinity magnification cannot help having resort to inaccurate measurement with the eye and eventually, gives rise to acquisition of mere aberration coefficient values containing errors.

An object of the present invention is to eliminate the above prior art drawbacks and according to the invention, a Ronchigram is acquired using a spherical specimen, various kinds of aberration coefficients are measured from inner and outer diameters of a ring pattern appearing in the Ronchigram and a radius of the specimen as well and a spherical aberration corrector is adjusted on the basis of the measured coefficients. Thus, without resort to direct measurement of a line of infinity magnification which is difficult to specify from the Ronchigram, the aberration coefficients can be measured. Besides, through the use of the spherical specimen, the aberration coefficients can be measured from image data of a single Ronchigram. In this manner, the adjustment time can be shortened expectantly.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams useful in explaining an optics for formation of a Ronchigram of a spherical specimen.

FIGS. 2A and 2B are diagrams showing examples of Ronchigrams

FIG. 3 is an external structural diagram of a scanning transmission electron microscope apparatus.

FIG. 4 is a diagram showing an internal structure of a scanning transmission electron microscope column.

FIG. 5 is a flowchart showing procedures of adjustment of an aberration corrector.

FIG. 6 is a diagram of a user interface used during adjustment of the corrector.

FIG. 7 is a diagram showing an example of a table for decision of measured aberration coefficients.

FIG. 8A is a diagram showing an example of a Ronchigram containing a rotational asymmetry aberration.

FIG. 8B is a diagram showing an example of a polar coordinate conversion image of the Ronchigram.

### DETAILED DESCRIPTION OF THE EMBODIMENTS

### Embodiment 1

(Principle of Determining Aberration Coefficients from Ronchigram)

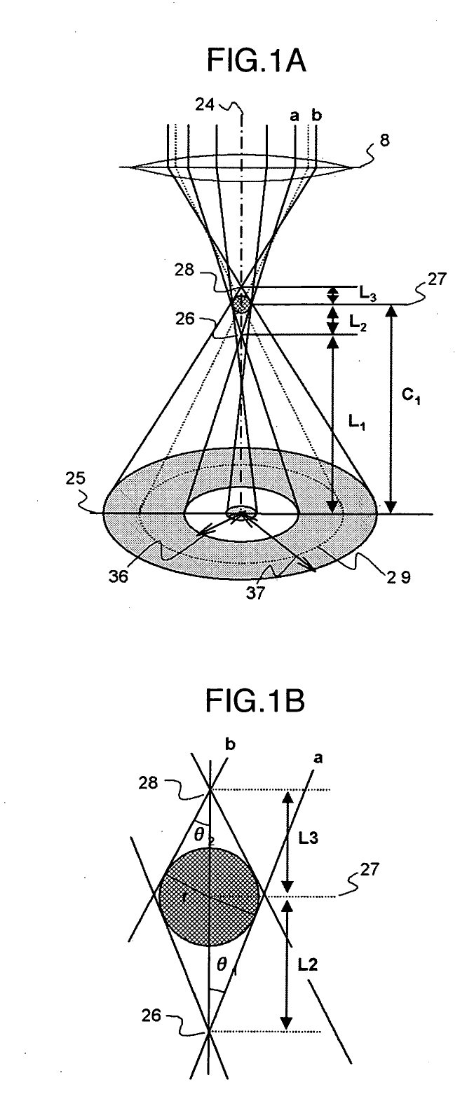

Referring first to FIGS. 1A and 1B, the principle of acquisition of a Ronchigram according to the present embodiment will be described. The Ronchigram is an image observed on the axis when scanning of an electron beam is stopped with the aperture released or an aperture of large hole diameter used and has a nature of susceptibly relecting an influence an aberration has upon the electron beam on the axis. Diagrammatically illustrated in FIG. 1A is an optics around a specimen at the time of acquisition of a Ronchigram in a transmission electron microscope/scanning transmission electron micrsoscope. In FIG. 1A, there are seen a pre-magnetic field of objective lens 8 and an optical axis, indicated by chained line 24, of a primary electron beam incident on the pre-magnetic field of objective lens. Normally, the primary electron beam optical axis 24 coincides with the center of pre-magnetic field of objective lens 8. At a position on a specimen plane 27 in the forward direction of travel on the primary electron beam optical axis 24, a spherical specimen for acquisition of a Ronchigram is mounted. Normally, the specimen is so disposed as to have its center axis coincident with the center axis of the pre-magnetic field of objective lens. The primary electron beam having transmitted through the specimen is focused under the specimen, forming an image plane 25.

The trajectory of the primary electron beam having entered the pre-magnetic field of objective lens 8 is curved by the action thereof and is then irradiated on the specimen. Assuming now that the primary electron beam incident on the pre-magnetic field of objective lens is formed of a plurality of electron beam components having different trajectories, an angle an arbitrary electron beam component having its trajectory curved by the pre-magnetic field of objective lens makes to the optical axis 24 is defined as a convergent angle. Some of the plural (virtual) electron beam components (hereinafter simply referred to as electron beams) incident on the pre-magnetic field of objective lens have, after transmission through the pre-magnetic field of objective lens, their trajectories which are tangential to the spherical specimen. Among such tangent forming electron beams, an electron beam is defined as an a-trajectory electron beam and an electron beam transmitting through a place being clearer of the center of pre-magnetic field of objective lens than the a-trajectory electron beam is defined as a b-trajectory electron beam. The principle will be described below on the assumption of all of the above conditions.

Next, a method of determining a spherical aberration coefficient will be described. For simplicity of explanation, only a third order spherical aberration is considered. In FIG. 1A, an electron beam having transmitted through the pre-magnetic field of objective lens 8 and traveling through the specimen by making a small convergent angle thereto, that is, at a place relatively close to the center axis of the pre-magnetic field of objective lens is focused on the image plane 25. But as the convergent angle increases, the electron beam is affected more intensively by a spherical aberration and as a result, caused to intersect the optical axis 24 at a position closer to the specimen. With the convergent angle further increased, the electron beam once fails to transmit through the specimen. When traveling on an-a trajectory having a further larger angle component, the electron beam again transmits through the specimen. As the convergent angle furthermore increases, the electron beam takes a b-trajectory which interests the optical axis 24 at a position closer to the pre-magnetic field of objective lens 8 than to the specimen plane 27 and again fails to transmit through the specimen. Accordingly, a Ronchigram acquired using the spherical specimen can be observed as having a ring pattern shown at the image plane 25 in FIG. 1A. As will be seen from the foregoing description, the radial distance of the ring pattern from the center of Ronchigram is proportional to the convergent angle of electron beam. Inner and outer radii 36 and 37 of the ring pattern are formed by electron beams corresponding to the trajectories a and b, respectively, and therefore, by measuring the inner and outer radii 36 and 37 of the ring pattern from the Ronchigram, convergent angles corresponding to the trajectories a and b can be determined. Due to the fact that the aberration coefficient is reflected in the divergent angle of the electron beam trajectory, the aberration coefficient can be estimated by calculating convergent angles of the a-trajectory electron beam and b-trajectory electron beam. It is to be noted that dotted line in FIG. 1A indicates an electron beam incident at a convergent angle meeting formation of a line 29 corresponding to infinity magnification on the image plane.

Next, the relation between each of the convergent angles of a-trajectory electron beam and b-trajectory electron beam and the aberration coefficient will be described. Like the above, in the light of only the third order spherical aberration coefficient, a description will be given below for simplicity of explanation. Illustrated in FIG. 1B is an enlarged view of the neighborhood of the specimen in FIG. 1A. Where the distance between a point 26 at which the a-trajectory electron beam intersects the optical axis and the image plane 25 is L₁, the distance between the point 26 at which the a-trajectory intersects the optical axis and the specimen plane 27 is L₂, the distance between a point 28 at which the b-trajectory intersects the optical axis and the specimen plane 27 is L₃, the radius of the spherical specimen is r, the convergent angles of the a-trajectory electron beam and b-trajectory electron beam are θ₁ and θ₂, respectively, and the third order aberration coefficient is C₃, the L₂ and L₃ can be expressed by

$$\begin{matrix}{L}_{2} = \frac{r}{{θ}_{1}} & ( 1 ) \\ {L}_{3} = \frac{r}{{θ}_{2}} & ( 2 )\end{matrix}$$

Since an amount of defocus caused by a spherical aberration is proportional to the product of spherical aberration coefficient C₃ and the square of electron beam convergent angle, equations 3 and 4,
C₃θ₂²=L₁+L₂+L₃ (3)
L₁=C₃θ₁² (4)
can be obtained from the illustration in FIG. 1A. By substituting equations 1, 2 and 4 for equations 3 and by solving the resultant equation for C₃,

$${C}_{3} = \frac{r}{{θ}_{1} {θ}_{2} ( {θ}_{2} - {θ}_{1} )} \qquad ( 5 )$$

can be obtained.

Further, as is clear from FIG. 1A, a defocus amount C₁ can be determined from equation 6,

$${C}_{1} = r ( \frac{1}{{θ}_{1}} - \frac{1}{θ 2} + \frac{1}{{θ}_{2} - {θ}_{1}} ) \qquad ( 6 )$$

A method of determining the convergent angles θ₁ and θ₂ from the inner and outer radii 36 and 37 of the ring pattern will be described hereunder. It should be understood from FIG. 1A that the convergent angles θ₁ and θ₂ are proportionally related to the inner and outer radii 36 and 37 of the ring pattern. In other words, what is needed to determine the convergent angles θ₁ and θ2 from the inner and outer radii 36 and 37 of the ring pattern is to merely know a change in convergent angle per pixel on an image from which the Ronchigram is acquired. Accordingly, a diffraction pattern of a crystalline specimen is imaged under the same lens condition as that during acquisition of the Rohchigram. By measuring a position of a diffraction spot from a crystal face of face distance d appearing in the diffraction image, a change in convergent angle per pixel can be calculated. Where the wavelength of an incident electron beam is λ, the relation between the diffraction spot associated with crystal face distance d and the convergent angle θ is given by θ=λ/d. Therefore, in case a specimen is used for which the crystal face distance d is known, a convergent angle per pixel can be calculated by measuring the number of pixels between adjacent diffraction spots in an acquired diffraction image corresponding to the specimen. In this manner, the inner and outer radii 36 and 37 of the ring pattern can be converted into convergent angles.

Thus, by measuring inner and outer radii of a ring pattern appearing in a Ronchigram, calculating convergent angles θ₁ and θ₂ of measuring a-trajectory and b-trajectory electron beams from the thus obtained values of inner and outer radii and substituting these values for equation 5, a value of C₃ can be obtained.

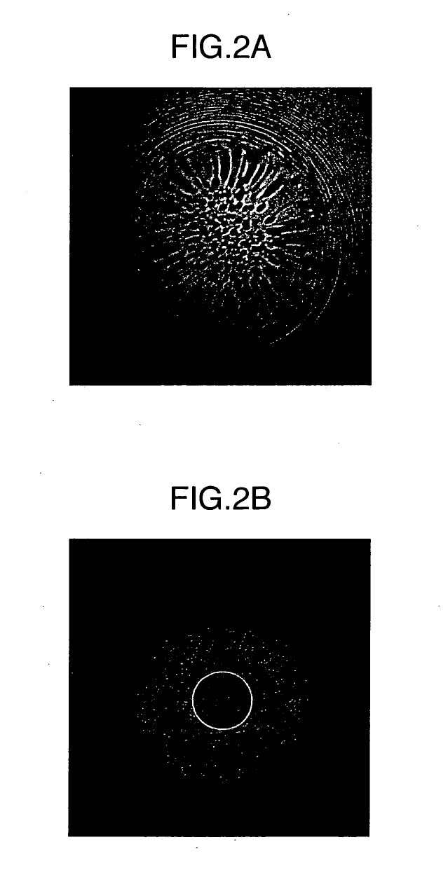

Turning now to FIGS. 2A and 2B, a conventional Ronchigram image obtained using an amorphous specimen and a Ronchigram image obtained according to the present embodiment by using a spherical specimen are illustrated comparatively in FIGS. 2A and 2B, respectively. Each image is a Ronchigram taken under an under focus condition. In the case of FIG. 2A, a specimen prepared by vapor-depositing gold particles on a carbon film is used and it will be seen that the Ronchigram obtained with this specimen is affected by a spherical aberration to exhibit so a sophisticated form that its infinity magnification ring pattern can hardly be specified. In trying to calculate an aberration coefficient from the Ronchigram through the conventional method, determination of an amount of change in diameter of the ring pattern concomitant with a defocus is necessary and so at least two Ronchigrams are needed. In the case of the Ronchigram shown in FIG. 2B, it will be appreciated that a circle appears in the center and a ring pattern surrounding the circle develops, exhibiting a form which is very simplified as compared to that using gold particles. Inner and outer radii of the ring pattern developing in the Ronchigram in FIG. 2B have information equivalent to that obtained from the position of the infinity magnification ring pattern of the Ronchigram imaged through the defocus change, that is, the same information content as that of two Ronchigrams in FIG. 2A. Namely, by using the spherical specimen, information content necessary for measurement of aberration coefficient increases in the Ronchigram to permit the aberration coefficient to be calculated from one Ronchigram.

Preferably, the spherical specimen for use in imaging a Ronchigram is formed of a material difficult for an electron beam to transmit therethrough, having as small a diameter as possible and a high degree of sphericity. Accordingly, latex raw material such as polystyrene or metal is suited for the spherical specimen. Conceivably, the spherical specimen may be either of a known particle diameter or of an unknown particle diameter. In using a spherical specimen of unknown particle diameter, a scanning transmission image of the specimen may be taken and its diameter may be measured.

For determination of an adjustment amount of the spherical aberration corrector on the basis of the obtained aberration coefficient, an excitation condition for lenses constituting the corrector must be determined from the aberration coefficient. For the sake of determining the excitation condition from the aberration coefficient, a known calculation formula can be utilized and the adjustment can be carried out using an excitation condition obtained pursuant to the calculation formula.

(Constitution of Apparatus for Acquisition of Ronchigram)

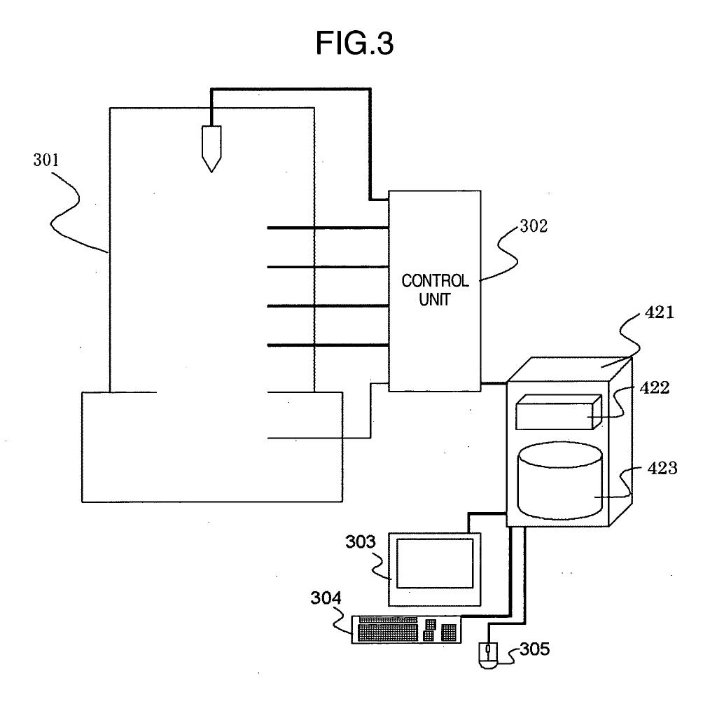

Next, an example of construction of a charged particle beam apparatus for determining an aberration coefficient from an acquired Ronchigram image will be described. A scanning transmission electron microscope according to the present embodiment is constructed externally as illustrated in FIG. 3.

Principally, the scanning transmission electron microscope comprises a column 301 thereof, a control unit 302, a display 303 and an information processor 421. The interior of column 301 is evacuated to vacuum and an electron source, various kinds of lenses, deflectors and detectors are provided internally of the column. With a view to reducing an influence an external disturbing magnetic field has upon an incident electron beam, the column 301 is made of a magnetic material. Current and voltage applied to the electron source, various lenses, deflectors and detectors provided internally of the column are controlled by means of the externally arranged control unit 302. The control unit 302 for the optics includes a power supply for application of current and voltage to the electron source, various lenses, deflectors and detectors, a drive power supply circuit controlled by a CPU 422 included in the information processor 421 and an A/D converter as well. The information processor 421 includes the CPU 422 and a memory unit 423, thus enabling the user to perform input/output of setting of the optics through the medium of an interface such as the display 303, a keyboard 304 or a mouse 305 in order to control the scanning transmission electron microscope via the information processor 421.

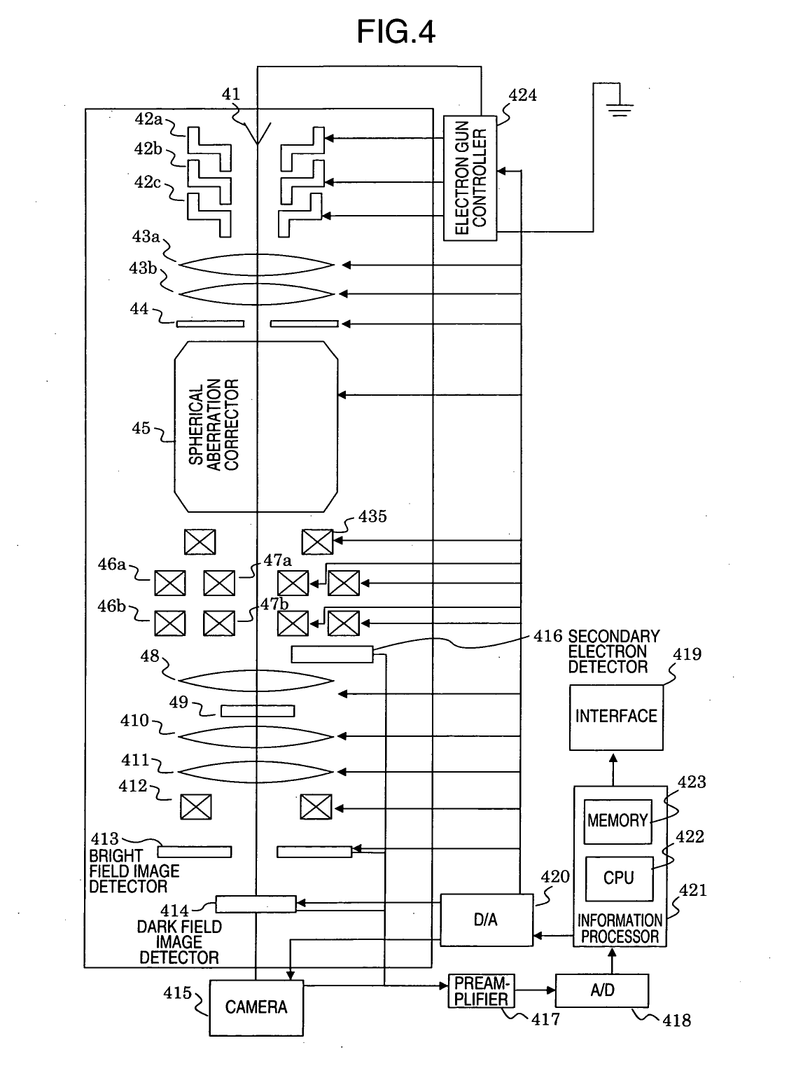

An internal structure of the scanning transmission electron microscope column shown in FIG. 3 is illustrated in FIG. 4. An electron beam emitted from an electron beam source 41 is accelerated with a predetermined accelerating voltage by means of electrostatic lenses 42a, 42b and 42c. By controlling voltage applied to one stage of electrostatic lens by way of electronic gun controller 424, an ultimate accelerating voltage can be controlled. The electron beam accelerated with the predetermined accelerating voltage is converged by means of condenser lenses 43a and 43b. A desired magnification rate can be realized by combining excitation currents of the lenses 43a and 43b. The aperture angle of a probe is changed by means of a condenser aperture 44 below the condenser lens 43b, so that the balance between spherical and diffraction aberrations which affect the probe can be adjusted. The condenser aperture 44 is cooperative with a moving mechanism so as to get clear of the optical axis.

The electron beam having passed through the condenser aperture travels in a spherical aberration corrector 45 where the electron beam is corrected for aberrations such as spherical aberration and astigmatism. The corrector 45 is a unit for correcting a third order spherical aberration which restricts most the resolution of the scanning transmission electron microscope. The corrector 45 in the present embodiment is constructed of either a multi-stage electrostatic lens or a magnetic field type multipole lens, a rotationally symmetric lens or a deflection coil. By controlling application voltage or excitation current to the multipole lens and the rotationally symmetric lens, the aberration correction amount can be adjusted.

In case the correction of astigmatism is insufficient, a further correction can be made using a stigmator coil 435 disposed under the spherical aberration corrector 45. In addition, with deflection coils 46a and 46b, the angle of incidence of the electron beam incident on the specimen can be controlled. The electron beam focused on a specimen 49 by means of a pre-magnetic field of objective lens 48 is scattered in the specimen and an electron beam diffraction image is formed under the specimen 49 by using a post-magnetic field of objective lens 410. A detection system alignment coil 412 arranged below a projection lens 411 is used for axial alignment relative to a dark field image detector 413, a bright field image detector 414 and a camera 415.

When the electron beam is made to be obliquely incident on the specimen by using the deflection coils 46a and 46b, the electron beam diffraction image suffers from a large axial misalignment in relation to the dark field image detector 413, bright field image detector 414 and camera 415 and in that case, the axial alignment is also conducted using the detection system alignment coil 412. A scanning transmission image can be acquired by deflecting the electron beam with scan coils 47a and 47b to scan it on the specimen 49 two-dimensionally and synchronously therewith, modulating in brightness a signal from the dark field image detector 413 or bright field image detector 414 to thereby provide image intensities to be finally acquired. The image intensity at that time is amplified by a preamplifier 417 and saved as a digital image file on the basis of an output from an A/D converter 418. The bright field image detector 414 is arranged on the optical axis and is therefore cooperative with a drive mechanism so as to get clear of the optical axis during the use of camera 415. Used as the camera 415 is a detector such as a CCD or HARPICON camera characteristic of high sensitivity, high S/N and high linearity so that the electron beam diffraction image or Ronchigram intensity may be recorded quantitatively. The camera length on the plane of camera 415 can be changed arbitrarily by means of the projection lens 411, thereby ensuring that an electron beam diffraction image and a Ronchigram on a desired image forming plane can be observed.

In a series of operations, all of the lenses, coils and detectors are controlled by the CPU 422 built in the information processor 421 through a D/A converter 420, permitting the operator to set conditions by way of an interface 419 such as a mouse, display or keyboard. A secondary electron detector 416 is arranged above the pre-magnetic field of objective lens 48 and so the scan image and a secondary electron image can be acquired. In taking a Ronchigram, scanning is stopped and imaging is conducted under a condition that the electron beam travels along the optical axis. Like the scanning transmission image, the imaged Ronchigram is saved as an image file in the memory unit 423 and can be called up any time through the interface 419.

Next, procedures of an adjustment of the aberration corrector mounted in the scanning transmission electron microscope shown in FIGS. 3 and 4 will be described. With the spherical aberration corrector mounted in the scanning transmission electron microscope, the third order spherical aberration can be corrected, thereby making it possible to observe the scanning transmission image with very high resolution. But for high resolution observation, adjustments of the various kinds of lenses included in the spherical aberration corrector must be made with very high accuracies. To this end, a fine adjustment of the corrector needs to be made each time observation is conducted with the aim of reducing a residual aberration sufficiently.

For accurate adjustment of excitation of the plural lenses included in the corrector, various kinds of aberration coefficients in the scanning transmission electron microscope are first measured through the method using the Ronchigram set forth so far. Subsequently, exciting conditions for correction of the various aberrations are calculated from the measured aberration coefficients and fed back to the corrector, thereby completing the adjustment. Through the procedures as above, high resolution observation can be performed.

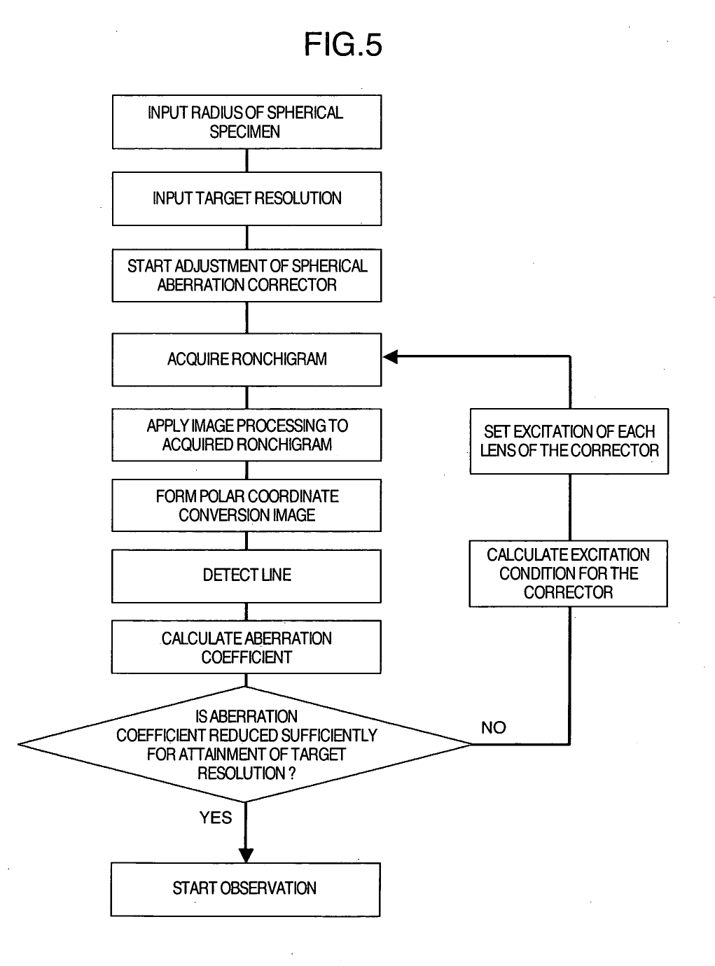

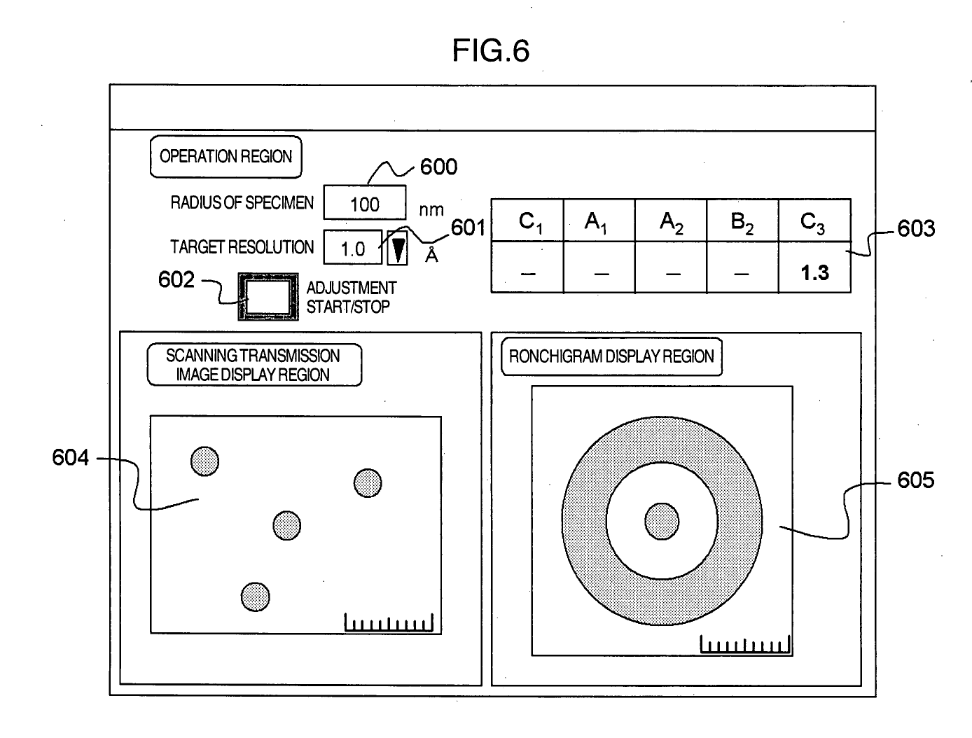

A flowchart showing steps executed during the adjustment of corrector is depicted in FIG. 5 and an example of GUI (Graphical User Interface) used during the adjustment of corrector is illustrated in FIG. 6. After the power supply in the STEM proper has been thrown in and preparation for acquisition of scanning transmission images has been made, a GUI necessary for normal observation of scanning transmission images is displayed on the interface. The normal observation is conducted by way of the GUI. In the case of adjustment of the corrector, an icon provided on the GUI for normal observation is clicked.

When the above steps end, a GUI screen shown in FIG. 6 is displayed on the user interface 419 shown in FIG. 4. An operation screen of the GUI shown in FIG. 6 is mainly divided into an operation region, a scanning transmission image display region and a Ronchigram display region. Arranged in the operation region are a text box 600 for inputting a radius of a specimen, a text box 601 for inputting a target resolution and an adjustment start/stop button 602. Following inputting of a radius of specimen and a target resolution, the user depresses the adjustment start/stop button 602 to start an adjustment of the spherical aberration corrector. When this button is depressed in the course of the adjustment, the adjustment can be stopped. Individual calculated aberration coefficients are collectively displayed in a table 603. In the table 603, C₁, A₁, A₂ and B₂ are described which designate defocus amount, first order 2-fold rotational symmetry astigmatism, second order 3-fold symmetry astigmatism and second order axial coma aberration coefficient, respectively, but their values are not indicated in the illustration because only spherical aberration coefficients are measured in the present embodiment.

In the scanning transmission image display region, a scanning image 604 such as a bright field image of the specimen, a dark field image of the specimen or an SEM image taken by the secondary electron detector is displayed. In the Ronchigram display region, a picked up Ronchigram 605 is displayed. A Ronchigram is imaged while stopping the electron beam scan and therefore, during acquisition of the Ronchigram, an image before stoppage of scan is displayed in the scanning transmission image display region. Even during adjustment of the corrector, imaging of a Ronchigram keeps continuing and a transition image of the Ronchigram is displayed.

Reverting now to FIG. 5, the flowchart will be described. Firstly, the radius of a spherical specimen used for adjustment is set and inputted. An operator inputs the set radius through the GUI of FIG. 6. The operator inputs a numerical value of the radius to be set in a “radius of specimen” in text box 600. Thereafter, the operator selects a numerical value to be set from a pull down menu on the right side of the “target resolution” text box 601 so as to input a targeted resolution. Subsequently, the operator clicks the adjustment start/stop button 602 and then an adjustment of the corrector starts. As soon as the adjustment of corrector is started, scanning of an electron beam is stopped automatically under the direction of a program incorporated in the information processor 421, followed by setting of the objective lens and projection lens to setting values stored in the memory unit in advance and acquisition of a Ronchigram under a consultation with cumulative time for image acquisition and acquiring image size which are set in advance in the memory unit.

Next, the information processor 421 applies to image data of the acquired Ronchigram image an image process which is executed for measurement of inner and outer radii of a ring pattern. Subsequently, the information processor 421 executes a step of calculating the aberration coefficient, so that an aberration coefficient can be calculated from values of the inner and outer radii and radius of the spherical specimen. In calculating the aberration coefficient, the information processor 421 makes reference to a calculation formula stored in the memory unit 423. In the flowchart of FIG. 5, a “formation of polar coordinate conversion image” step is indicated as succeeding the step of image-processing the Ronchigram image but in present embodiment, an aberration coefficient is calculated without resort to an polar coordinate conversion image (detailed in embodiment 2). Accordingly, the step of image-processing the Ronchigram image is not followed by execution of the steps of “forming polar coordinate conversion image” and “detecting line” but the step of “calculating aberration coefficient” is directly executed.

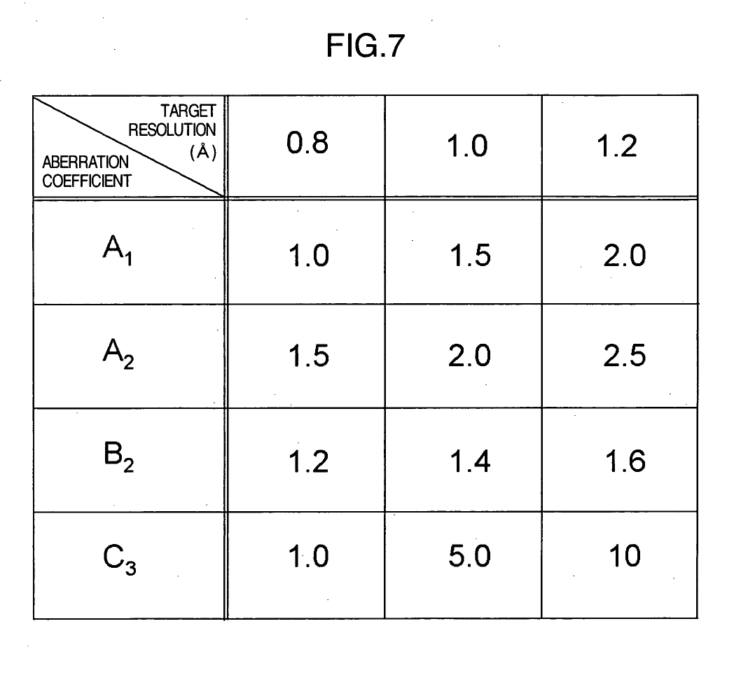

With the aberration coefficient computed, the information processor 421 consults a decision table stored in the memory unit 423 to decide whether the obtained value of aberration coefficient is sufficient to perform high resolution observation. An example of the decision table is shown in FIG. 7. The decision table shown in FIG. 7 has a plurality of target resolution fields. Each field includes a plurality of aberration coefficient records corresponding to kinds of aberrations to be corrected. Stored in the aberration coefficient record is a value of each aberration coefficient necessary for attaining the target resolution. For attainment of the target resolution, a measured aberration coefficient must be smaller than the value described in the table. Therefore, the information processor 421 compares a calculated aberration coefficient with the value of decision table, thereby making a decision as to whether the calculated aberration coefficient is sufficiently smaller than the target resolution set in a text box 601 shown in FIG. 6. In the present embodiment, only a value of C₃ is compared.

If the computed C₃ is determined as being sufficient for attainment of the target resolution, the adjustment of the corrector ends and the operation shifts to scanning transmission image observation. If insufficiency is determined, such a lens exciting condition for the corrector as suitable for aberration correction is calculated from the computed aberration coefficient and the condition is fed back to the individual lenses via the control unit 302 of scanning transmission electron microscope. The above procedure is repeated until the aberration coefficient can be reduced sufficiently, so that the adjustment of the spherical aberration corrector can be accomplished.

The method of the present embodiment can assure more accurate measurement of C₃ than the prior art. Accordingly, the frequency of reiterative corrector adjustment operations can be reduced and the adjustment can be completed within a shorter time.

### Embodiment 2

In embodiment 1, the method has been described according to which the aberration corrector is adjusted such that the three order residual spherical aberration can be reduced. Actually, however, the primary electron beam irradiated on the specimen involves other aberrations than the three order spherical aberration and hence the aberration corrector must be adjusted so that aberrations inclusive of other kinds may be corrected as a whole. Then, in the present embodiment, a method for aberration corrector adjustment capable of reducing other aberrations as well will be described.

Firstly, parameters necessary to determine an aberration coefficient other than the three order spherical aberration will be described with reference to FIGS. 1A and 1B.

Angle θ_{inf} of an incident electron beam when the Ronchigram image exhibits infinity magnification is determined from the following equation.
θ_{inf}=\sqrt{θ₂²+θ₁²−θ₁θ₂} (7)
The electron beam entering at this angle θ_{inf} forms the line 29 corresponding to the infinity magnification in the image 25 shown in FIG. 1A. In an actually imaged Ronchigram image, this line is involved in a ring pattern having substantially uniform contrast.

Next, an instance where an astigmatic aberration is involved will be considered. With a first order 2-fold rotational symmetry astigmatic aberration involved, an electron beam has an elliptical spot. As a result, a convergent angle component of the electron beam transmitting through a spherical specimen changes, causing the ring pattern of Ronchigram to change to an ellipse. A trajectory of electron beam forming a major axis of the elliptic ring pattern at that time is maximized in defocus amount and convergent angle as well in contrast to a minor axis forming trajectory which is minimized in defocus amount and convergent angle. When the convergent angle changes by a₁ owing to a first order 2-fold rotational symmetry astigmatism, the maximum convergent angle can be indicated as θ→θ_{inf}+a₁, the minimum convergent angle can be indicated as θ→θ_{inf}−a₁, the maximum defocus amount can be indicated as C₁→C₁+A₁ and the minimum defocus amount can be indicated as C₁→C₁−A₁, where A₁ is a second order 2-fold rotational symmetry astigmatism coefficient. From the above, A₁ is expressed as below.
A₁=2a₁θ_{inf}C₃ (8)
In case only a second order 3-fold rotational symmetry astigmatism is involved, the ring pattern changes triangularly. Where a change of defocus is A2θ_{inf} at that time and a change of convergent angle due to the second order 3-fold rotational symmetry astigmatism is a₂, a second order 3-fold rotational symmetry astigmatism coefficient A₂ is expressed as below.
A₂=2a₂C₃ (9)
In case only a second order axial coma aberration is involved, the ring pattern is elongated in one direction. By using a change of convergent angle b₂, a second order axial coma aberration coefficient B₂ is expressed as below.
B₂=2b₂C₃ (10)
Generally, an n-th order rotational asymmetry aberration coefficient P is expressed as below by using a change p of convergent angle due to the aberration.
P=2pC₃θ_{inf}⁻ⁿ⁺² (11)

Accordingly, what is necessary to determine the first order 2-fold rotational symmetry astigmatism coefficient and second order 3-fold rotational symmetry astigmatism coefficient is to make θ_{inf}, a₁ and a₂ known, and by making b₂ known, the second order axial coma aberration coefficient can be determined.

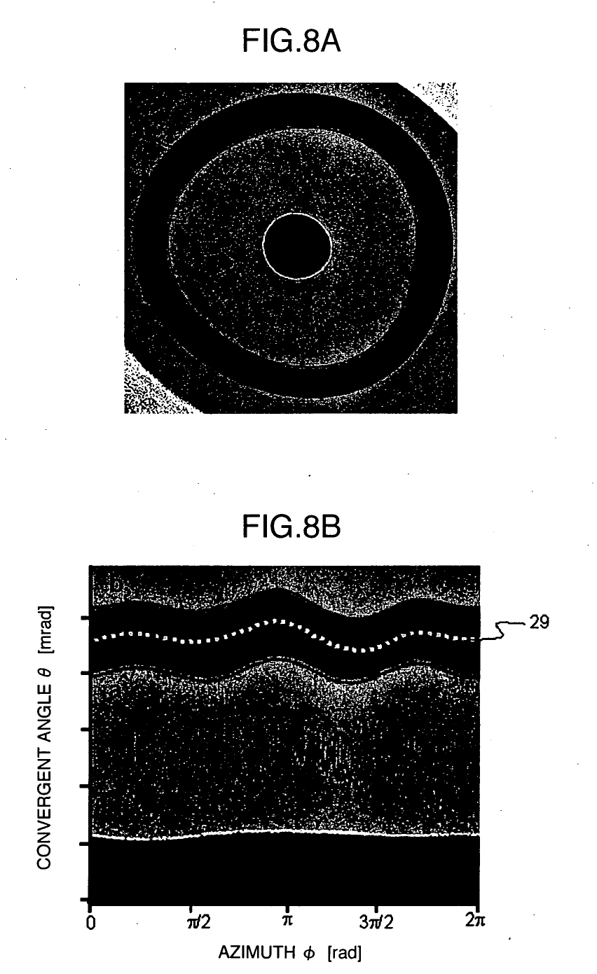

Next, a method of measuring the parameters as above will be described. In contrast to the Ronchigram shown in FIG. 2B substantially involving only spherical aberration and defocus component to permit appearance of the rotationally symmetrical ring pattern, a Ronchigram involving all concurrent aberrations is rotationally asymmetrical as shown in FIG. 8A. Accordingly, for measurement of aberration coefficients corresponding to individual aberrations, a component corresponding to each aberration must be separated from the Ronchigram of FIG. 8A. To this end, the acquired Ronchigram is converted to the polar coordinate form having its origin in the center of the Ronchigram. Through the method as above, convergent angles corresponding to the inner and outer radii of the ring pattern can be measured accurately.

Referring to FIGS. 8A and 8B, an example of polar coordinate conversion image will be described. In FIG. 8B, ordinate represents convergent angle θ and abscissa represents azimuth φ. Lines a and b in these figures correspond to convergent angles θ₁ and θ₂ for the a-trajectory electron beam and b-trajectory electron beam in FIG. 1A, respectively. A line 29 appearing in the polar coordinate conversion image of FIG. 8B corresponds to an infinity magnification determined from convergent angles corresponding to the individual azimuth angles of lines a and b.

As has been explained in connection with embodiment 1, θ_{inf} can be computed by calculating θ₁ and θ₂ on the basis of values of inner and outer radii determined from the Ronchigram of FIG. 8A and substituting the thus obtained values of θ₁ and θ₂ for equation 7 but it can otherwise be calculated from the lines a and b appearing in the polar coordinate conversion image of FIG. 8B, providing its value more accurately. The lines a and b appearing in the polar coordinate conversion image to be described below are curved because they are affected by rotationally asymmetrical aberrations such as astigmatism and coma aberration. The focal position shift attributable to the spherical aberration and defocus, on the other hand, takes place rotationally symmetrically and therefore, values in azimuth direction of each of the convergent angles corresponding to the lines a and b are averaged to provide mean values which are equal to θ₁ and θ₂ in equation 5, respectively. Therefore, by substituting θ₁ and θ₂ obtained from the mean values in azimuth direction of the convergent angles corresponding to the line a and b for equation 7, θ_{inf} can be obtained. Also, by rewriting equation 5 with θ₁ and θ₂ in this manner, C₃ can be measured more accurately than by the method explained in embodiment 1.

For determination of a₁ and a₂, individual aberration components contained in the line 29 in FIG. 8A must be separated from one another. When the electron beam involves only a first order 2-fold rotational symmetry astigmatism, a ring pattern appearing in a Ronchigram is an ellipse and the line corresponding to the infinity magnification after polar coordinate conversion takes the form of a waveform of period π. If only a second order 3-fold rotational symmetry astigmatism component is involved, the ring pattern is triangular and the line is of a waveform of 2/3π period and if only a second order axial coma aberration is involved, the line is of a waveform of 2π period. As a method for separation of the line 29 to the individual period components, a Fourier series expansion, for example, may be used. In the Fourier series expansion, the line 29 in FIG. 8B is extracted as a function θ(φ) having a variable of azimuth angle φ and the function θ(φ) is subjected to the Fourier series expansion. Since amplitudes of waveforms of period π, period 2/3π and period 2π separated through the Fourier series expansion correspond to a₁, a₂ and b₂, respectively, the 2-fold and 3-fold rotational symmetry astigmatism coefficients and second order axial coma aberration coefficient can be determined. By using the method as above, other rotational asymmetry aberration coefficients can be measured.

Now, the apparatus operation when the aberration corrector adjusting method according to the present embodiment is applied to the STEM shown in FIGS. 3 and 4 will be described. The external view and internal construction of the STEM has already been described in connection with embodiment 1 and so will not be described herein. It should however be understood that the program stored in the memory unit 423 of the STEM according to the present embodiment is different from that in the case of STEM described in connection with embodiment 1. Accordingly, operation of the information processor 421 differs from that for the STEM in embodiment 1.

Then, by using the flowchart of FIG. 5, an aberration coefficient calculation method for use in the STEM of the present embodiment will be described. The apparatus operates similarly to embodiment 1 in the step of “inputting radius of spherical specimen” through the step of “image-processing acquired Ronchigram image” and so a description of these steps will not be given herein. For input operation to be executed by the operator, a GUI similar to that in FIG. 6 described in embodiment 1 can be utilized.

Image processing such as noise removal and binary digitalization is performed and a polar coordinate conversion image is formed. Subsequently, lines corresponding to inner and outer radii of a ring pattern are detected from the polar coordinate conversion image and extracted as a function θ(φ) of convergent angle in terms of azimuth φ.

To detect the line in the ring pattern from the polar coordinate conversion image of Ronchigram, elimination of noise is first performed. Thereafter, the line is detected, with a Fresnel fringe due to a defocus developing at the edge of the ring pattern. Then, the boundary between black and white lines at the ring pattern edge is detected as a line of the ring pattern. For detection, after the polar coordinate conversion image is applied with a process of, for example, binary digitalization or edge emphasis, pixels in the processed image that meet a specified condition such as threshold value are detected.

Subsequently, a function θ(φ) induced by the line detection is subjected to a Fourier series expansion so as to be separated into waveforms of period components reflecting individual aberrations. Thus, amplitude of the waveform of each period can be determined and each aberration coefficient can be calculated pursuant to the aforementioned equation. The individual aberration coefficients now calculated are displayed in the table 603 of GUI in FIG. 6.

As in the case of embodiment 1, the calculated aberration coefficient is compared with a value described in the decision table so as to be decided as to whether to be sufficient to attain a target resolution. In the present embodiment, the sufficiency of not only the C₃ value but also all calculated aberration coefficients is decided.

When the calculated aberration coefficients are determined as being sufficient for attainment of the target resolution, the adjustment of the spherical aberration corrector ends, proceeding to observation of a scanning transmission image. If insufficiency is determined, a lens exciting condition (for example, a current correction amount applied to the pole) of the spherical aberration corrector necessary for correcting the aberration is calculated from the computed aberration coefficients and is fed back to the individual lenses through the control unit 302 of STEM. This procedure is repeated until the individual aberration coefficients can be reduced sufficiently, thereby completing the adjustment of the spherical aberration corrector.

It will be appreciated that according to the method of embodiment 2, not only the spherical aberration but also a rotationally asymmetrical aberration can be measured. Accordingly, as compared to the method shown in embodiment 1, more practical method or apparatus for high resolution measurement can be materialized.

It should be further understood by those skilled in the art that although the foregoing description has been made on embodiments of the invention, the invention is not limited thereto and various changes and modifications may be made without departing from the spirit of the invention and the scope of the appended claims.

1. A scanning transmission electron microscope comprising:
a scanning transmission electron microscope column including an electron optics having an aberration corrector comprised of a plurality of lenses so as to scan an electron beam corrected for aberrations by said corrector on an object and a detector for detecting the electron beam having transmitted through said object;
an information processor for processing a detection signal of said detector to form a scanning transmission electron beam image; and
memory means for storing image data of the scanning transmission electron beam image formed by said information processor,
wherein said information processor calculates, from image data of a Ronchigram image obtained from a spherical specimen, inner and outer radii of a ring pattern appearing in the Ronchigram image, calculates an aberration coefficient for said aberration corrector from the thus obtained inner and outer radii, and calculates excitation conditions for a plurality of lenses from the aberration coefficient.

2. A scanning transmission electron microscope according to claim 1 further comprising:
a power supply for supplying excitation voltage to said plurality of lenses;
means for controlling the voltage supplied from said power supply; and
transmission means for transmitting excitation conditions for the plurality of lenses calculated by said information processor to said control means.

3. A scanning transmission electron microscope according to claim 1 further comprising image display means for displaying the Ronchigram image.

4. A scanning transmission electron microscope according to claim 1, wherein said Ronchigram image is one which is obtained when either a spherical metal specimen or a latex ball is used as said object.

5. A scanning transmission electron microscope according to claim 1, wherein a Ronchigram image before the excitation condition is corrected by the calculated lens excitation condition and a Ronchigram image after completion of the correction are displayed on said image display means.

6. A scanning transmission electron microscope according to claim 1, wherein said memory means includes a table for the correspondence of said inner and outer radii with said aberration coefficient.

7. A scanning transmission electron microscope according to claim 1, wherein said information processor presumes a diameter of ring pattern corresponding to infinity magnification from the inner and outer radii of said ring pattern, and calculates said aberration coefficient by using the diameter of ring pattern of infinity magnification.

8. A scanning transmission electron microscope according to claim 7, wherein said memory means includes a table for the correspondence of said diameter of ring pattern corresponding to the infinity magnification and said aberration coefficient.

9. A scanning transmission electron microscope according to claim 1, wherein said memory means stores initial setting conditions for excitation conditions of said plurality of lenses constituting said aberration corrector.

10. A scanning transmission electron microscope according to claim 9, wherein upon startup of the apparatus, excitation voltages based on said initial setting conditions are applied to said plurality of lenses and a Ronchigram image obtained when said aberration corrector is operated under said initial setting conditions is displayed on said image display means.

11. A method of adjusting a scanning transmission electron microscope having an aberration corrector constructed of a plurality of lenses, comprising the steps of:
acquiring a Ronchigram image of a spherical specimen;
determining inner and outer radii of a ring pattern appearing in the Ronchigram of said spherical specimen; and
calculating an aberration coefficient for said corrector by using values of said inner and outer radii and a diameter of the spherical specimen to determine excitation conditions for said plurality of lenses from the obtained aberration coefficient.

12. A method of adjusting a scanning transmission electron microscope according to claim 11 further comprising the steps of:
presuming from said inner and outer radii values and said diameter of the spherical specimen a diameter of an infinity magnification correspondence ring pattern appearing in said ring pattern; and
determining excitation conditions for said plurality of lenses from a value of said diameter of the infinity magnification correspondence ring pattern.
